(19) United States
(12) Patent Application Publication
(10) Pub. No.: US 2025/0289016 A1
(43) Pub. Date: Sep. 18, 2025

(54) CONDUIT DEVICE AND METHOD FOR IMPROVED EVACUATION OF MEDIA

(71) Applicant: Modern Planet, Inc., Buffalo, NY (US)

(72) Inventors: Cynthia Fairbanks ALLEN, Buffalo, NY (US); Brian Howard ALLEN, Buffalo, NY (US); Daniel P. KOWALIK, Orchard Park, NY (US)

(21) Appl. No.: 19/079,099

(22) Filed: Mar. 13, 2025

Related U.S. Application Data
(60) Provisional application No. 63/565,942, filed on Mar. 15, 2024.

(51) Int. Cl. B05B 11/00

(52) U.S. Cl. CPC B05B 11/0089

(57) ABSTRACT

A conduit device having a media tube having a first end and a second end defining a first passageway therein, first end having a flange extending radially therefrom, and a substantially helical frame extending from the second end of the media tube, the helical frame having a nodule affixed to a distal end thereof, wherein one or more of the media tube or the helical frame is adapted to be at least partially arranged within a deformable media container, thereby creating a media passageway within the helical frame when the deformable media container collapses around the helical frame. A method of improving evacuation of media within a deformable container, which may employ the aforementioned conduit device, is also disclosed.

### CROSS-REFERENCE TO RELATED APPLICATIONS

This application claims priority pursuant to 35 U.S.C. 119 (e) to U.S. Provisional Patent Application No. 63/565,942, filed Mar. 15, 2024, which application is incorporated herein by reference in its entirety.

### FIELD

The present disclosure generally relates to a conduit device design to assist evacuation of media contained within one or more of a deformable container, semi-deformable container, or a single-use container and/or package. The present disclosure also relates a method for improved evacuation of media from with one or more of a deformable container, semi-deformable container, or a single-use container.

### BACKGROUND

Current offerings for many household products, personal care products, cosmetic, food and condiments generally utilize single-use containers, dispense media contents therein in a messy fashion, and generally have an unappealing aesthetic. These containers include soap dispensers, toothpaste containers, lotion dispensers, and the like. Generally, little advancement has occurred in the design.

Many of these containers and/or packages have a deformable nature, or at least are semi-deformable, i.e., are at least semi-malleable, such that compression, force, etc., can at least partially collapse the container at least temporarily, thusly pushing and moving media contained therein, in a direction towards an outlet of the container and eventually dispense the media from the outlet. A known issue with these containers is the inability to fully empty the container, as the compression, force, etc., usually creates spaces where media becomes trapped after extensive compression, force, etc., has been applied thereto. One type of these containers, which is considered deformable, are known as pouches, squeeze pouches, or squeeze storage pouches.

Commonly, these deformable containers, or pouches are used for baby food and are generally classified as stand-up pouches, three-side seal flat bags, and/or spouted stand-up pouches, generally, “barrier bags”. Barrier bags, or pouches, for baby food are made from multiple layers of laminated barrier film, i.e., a membrane.

Semi-deformable containers are present issues, including being primarily designed as single-use containers. These containers may often include dispensers. In the case of soap dispensers, e.g., a semi-deformable container, media therein cannot be completely evacuated, therefore leading to unnecessary waste, in addition to the dispenser being a single-use application.

In the case of toothpaste tubes, containers and/or packages, general dispensing thereof is messy and inconsistent especially as it empties, nor is the amount dispensed consistent. Further, these containers, generally a type of deformable container, typically include a flip-top cap or a threaded cap, which opening and closing becomes restricted from excess toothpaste present thereon if a spout of the tube is not continuously cleaned. Even further, the act of dispensing toothpaste, vis-à-vis manual squeezing of the tube does not guarantee complete use of the entity of the toothpaste, especially as the container depletes, thus, product goes unused and is wasted.

Lotion dispensers, such as pump-like containers, or tubes similar to toothpaste tubes, present the same issues of one or more of the soap dispensers, packaging or toothpaste tubes.

As recited above, the waste contributed to landfills, or oceans, can take up to 500 years to biodegrade these containers. It can be generally said that these known-in-art single-use containers are wasteful and deformable containers are equally as wasteful, considering the contents therein is rarely evacuated completed.

It should be noted that the aforementioned containers are non-limiting. Additional single-use containers include condiment containers and/or dispensers, cleaning products, and other foreseeable containers or dispensers using single-use packaging.

As described herein and above, “media” could also encompass contents that may be a thick viscous fluid.

Therefore, there is a long felt need for a device that can integrate with known containers, which device is design to increase the efficiency of media evacuation, i.e., able to dispense a substantial entirety of media contents therein, which device is further designed to integrate with a pump mechanism, removing the need to manual compress or apply force, to containers having a deformable body, where the device is not a true conduit but still assists in directing media contents towards an outlet upon force application.

### CITATIONS

The following patents are all incorporated herein by reference in their entireties: U.S. Pat. No. 5,156,300, issued Oct. 20, 1992; U.S. Pat. No. 5,305,921, issued Apr. 26, 1994; U.S. Pat. No. 10,391,509, issued Aug. 27, 2019; and, U.S. Pat. No. 11,752,513, issued Sep. 12, 2023.

### SUMMARY

The disclosure broadly relates to conduit device, rather, a device arranged to create a wall-less passageway, which device assists in the evacuation of media from a container, a deformable container, and/or similar equivalents thereof. The disclosure also generally relates to a method of improving evacuation of media within a deformable container, which may employ the aforementioned conduit device. The device and the method of the disclosure both achieve a substantial emptying of media from container, that is otherwise not available absent the device and/or the method.

In one aspect, the present invention may comprise a conduit device having a media tube having a first end and a second end defining a first passageway therein, and a substantially helical frame extending from the second end of the media tube, the helical frame having a nodule affixed to a distal end thereof, wherein one or more of the media tube or the helical frame is adapted to be at least partially arranged within a deformable media container, thereby creating a media passageway within the helical frame when the deformable media container collapses around the helical frame.

In further possible aspects, the aforementioned conduit device may further comprise an outer tube having a first end and a second end, the outer tube having the first passageway arranged therein and proximate the first end and a second passageway arranged therein and proximate the second end, wherein the media tube is arranged at least partially within the second passageway and affixed proximate the first end.

In some embodiments, an outer surface of the media tube and an inner surface of the second passageway are spaced apart.

In other embodiments, threading may be arranged on an outer surface of the outer tube proximate the first end and threading may be further arranged on the inner surface of the second passageway proximate the second end.

In further embodiments, the threading of the inner surface of the second passageway is adapted to be threadably secured to a threaded portion of the deformable media container.

In even further embodiments, the threading of the outer surface of the outer tube is adapted to be threadably secured to a dispenser assembly-alternative, the outer tube may be fixedly secured to a dispenser assembly-thereby fluidly connecting the media tube and the dispenser assembly.

In one possible configuration, the nodule of the aforementioned conduit device may be configured as one or more of: substantially spherical, substantially hemispherical, substantially cylindrical, substantially annular, or a partial loop.

In another possible aspect, the present invention may comprise a conduit device including a media tube having a first end and a second end defining a first passageway therein, a wall-less frame extending from the second end of the media tube, the wall-less frame having at least one frame member extending distally from the second end of the media tube, wherein one or more of the media tube or the wall-less frame is adapted to be at least partially arranged within a deformable media container, thereby creating a media passageway within the wall-less frame when the deformable media container collapses around the wall-less frame.

In some embodiments, wherein said at least one frame member comprises a helical frame.

In other embodiments, the conduit device may further comprise a nodule affixed to a distal end of said wall-less frame.

In some other possible, the device may have one end with a conical shape that is designed to be affixed to a dispenser head.

In even further embodiments, the nodule of the conduit device may be configured as one or more of: substantially spherical, substantially hemispherical, substantially cylindrical, substantially annular, a partial loop, a closed end, or an open end.

In one possible configuration, the conduit device may further comprise a dispenser assembly having a dispenser passageway arranged therein, wherein, the dispenser assembly is connected to the media tube, thereby fluidly connecting the passageways and forming an evacuation passageway for media within the deformable media container to travel from the deformable media container and out of the dispenser assembly.

The present invention may further comprise a method for improving evacuation of media within a deformable container, the container having an internal chamber in fluid communication with an outlet, the method comprising the steps of: inserting a wall-less frame within the outlet to be seated within the internal chamber, the frame being connected to a tube and the tube being arranged to be at least partially seated within the outlet; forming, via the frame, a media passageway to the outlet; and, maintaining, via the frame, the media passageway to the tube when the internal chamber collapses as media is evacuated therefrom.

In some configurations, the aforementioned wall-less frame may comprise a helical frame.

In other configurations, the wall-less frame may comprise at least one frame member extending from the tube.

In further configurations, the wall-less frame may have a nodule arranged on an end opposite the tube.

In some embodiments, the aforementioned method may further comprise the step of: connecting an actuator to the tube, thereby allowing the actuator to create a vacuum within the internal chamber upon actuation, which actuation collapses the internal chamber as media is evacuated therefrom.

These and other objects, features, and advantages of the present invention will become readily apparent upon a review of the following detailed description of the invention, in view of the drawings and appended claims.

### BRIEF DESCRIPTION OF THE DRAWINGS

Various embodiments are disclosed, by way of example only, with reference to the accompanying schematic drawings, in which corresponding reference symbols indicate corresponding parts, in which:

FIG. 1 shows a perspective view of the present invention engaged with a media container;

FIGS. 2A and 2B show perspective skeleton views of a conduit device of the present invention;

FIGS. 3A and 3B shows perspective views of a further embodiment of the invention shown in either FIG. 2A or 2B;

FIG. 4 is a semi-cross-sectional view taken generally along line 4-4 in FIG. 3B;

FIG. 5A shows an outer container and dispenser having the invention shown in FIG. 1 arranged therein;

FIG. 5B is the cross-sectional view taken generally along line 5B-5B in FIG. 5A;

FIGS. 6A-6D generally illustrate enlarged views of an end of the conduit device shown in FIG. 2;

FIG. 7 shows an alternative embodiment of the invention shown in either FIG. 2A or 2B;

FIGS. 8A and 8B show a further alternative embodiment of the invention shown in one or more of FIG. 2A, 2B, or 3A and 3B;

FIG. 8C shows an exploded view of the invention shown in FIG. 8A with a portion of the cross-sectional shown in FIG. 5B;

FIG. 9 illustrates a method of the present invention generally using one of the one or more embodiments of the present invention;

FIG. 10 illustrates the conduit device shown in FIG. 2B connected to a dispensing actuator; and,

FIG. 11 is a cross-sectional view of the invention shown in FIG. 10.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and, as such, may, of course, vary. It is also understood that the terminology used herein is for the purpose of describing particular aspects only and is not intended to limit the scope of the claims.

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments. The system of the present disclosure, e.g., an actuator, could be driven by hydraulics, pneumatics, leveraging pressure (including vacuums) and/or springs.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein.

As used herein “media” is intended to mean a substance that is traditionally packaged in a single-use container or dispenser (examples of such are described supra) and is not to be considered limiting on the scope of the appended claims. Media generally means a liquid-like substance and is not limited to the viscosity of a particular liquid-like substance.

As also used herein, “fluid communication”, “communication”, and/or substantial equivalents thereof, is meant to mean two or more components are connected such that a substance, e.g., gases, fluid, etc., can flow between and/or within the two components.

As further used herein, “deformable” is intended to be substantially synonymous with like-terms, such as, but not limited to, “flexible,” “pliable,” “malleable,” “compliant,” “bendable,” “squeezable,” etc.

The term “conduit”, as used herein, is intended to mean a channel, pathway, passageway, and/or other like derivatives, for conveying water, other fluid, media, or material, therethrough or substantially therethrough, or for. Thus, “conduit” may be modified to mean a “closed conduit”, which should be understood as a substantially direct pathway, e.g., material is conveyed from location “A” to location “B” through and within the conduit, or “conduit” may be modified to mean an “open conduit”, which should be understood as an substantially indirect pathway, e.g., material is guided from location “A” to location “B” through and within the conduit, but also proximate the conduit, therefore material may enter an “open conduit” at location between location “A” and location “B”.

The term “tube”, as used herein, is intended to mean a closed conduit, e.g., pipe-like, having a pair of openings at oppositely disposed ends, which openings are in fluid communication with each other, and further, “tube” is not intended to be restricted to a specific shape, configuration or geometry, although cylindrical is preferred, cylindrical is not an exclusive geometry.

This disclosure details a wall-less frame that is designed to support a deformable container collapsing substantially therearound while preventing the container from substantially entering an area within and bounded by the wall-less frame. In one iteration, the wall-less frame may be a helical frame surrounding an inner area, which may be described as a sub-component of the conduit device of the present invention and could also be described as a helix-shaped vertical coil apparatus/mechanism. In another possible iteration, the wall-less frame may have a plurality of frame members surrounding an area within the plurality of frame members, an example being a wire-frame with a plurality of connected wires. In view of the appending description, claims, and corresponding drawings, the following details the functional benefits imparted by the structural configuration of the wall-less frame:
a. The wall-less frame serves as an air-path and a non-clogging apparatus/mechanism for a flexible packaging media chamber, e.g., one ore more of a deformable container or a semi-deformable container, to allow a respective dispenser to effectively vacuum or suction a media within the container by maintaining a ballooned, or spaced-apart, area where the helical frame is arranged within the container, thereby forming a passageway or pathway for media to be vacuumed, suctioned, evacuated, etc., from the container via a pressurized or vacuum pump action imparted by the respective dispenser.
b. The wall-less frame ensures the container does not collapse while simultaneously ensuring a constant air-path for media to the area of evacuation/extraction.
c. The wall-less frame substantially prevents a flexible pouch, bag, deformable container, semi-deformable container, etc., from deflating onto itself while simultaneously ensuring a contest air-path for media to flow, suction, and/or vacuum for evacuation and/or extraction.
d. The wall-less frame ensures an inner chamber and/or cavity of the container does not suction to itself, nor collapse unto itself, thereby ensuring a constant air path for media to be evacuated and/or extracted through a respective outlet.
e. The wall-less frame ensures the inner chamber and/or cavity remains as one fluidly connected chamber and/or cavity, i.e., does not bifurcate in multiple chambers, e.g., walls abutting via suction and the like.
f. A nodule arranged at a distal end of the wall-less frame acts as a guiding navigator as it plunges through the container and any media contained therein, which benefits and/or simplifies the manufacturing process.
g. The nodule also functions as a mounting component for a plurality of frame members of the wall-less frame to be mounted on, which frame members extend from a tube of the conduit device.
h. The nodule of the wall-less frame, due to is configuration, e.g., no hard, sharp, defined edges, ensures that a membrane, walls, etc., of the container is not punctured, also benefiting the manufacturing process and eliminating potential leaks and/or spillage during transportation of the container.

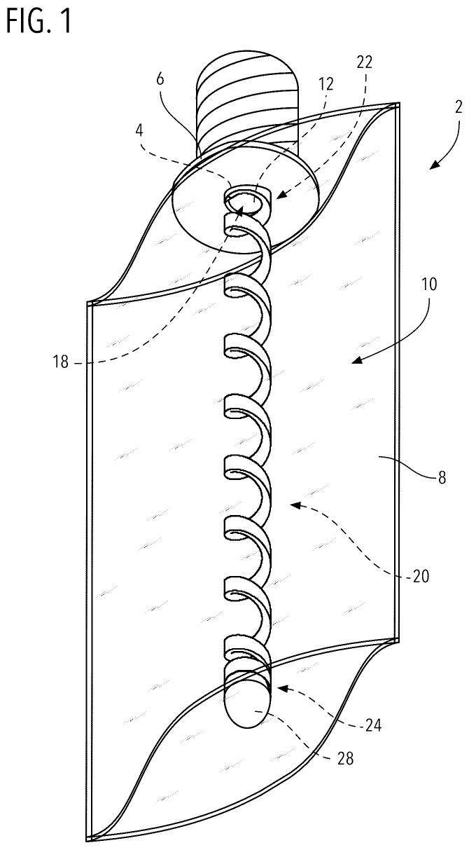

Adverting now to the figures, FIG. 1 shows an embodiment of the present invention, conduit device 10 arranged within media container 2. Media container 2 is a representation of one of a plurality of different media containers, described supra and infra, and may include outlet 4, i.e., a through-bore or media passageway, arranged with collar 6, where deformable container 8 extends from collar and substantially resembles a sealed bag-like container, but for outlet 4. As shown, conduit device 10 is removably engaged with media container 2, such that media tube 12 of conduit device 10 is removably and sealable engaged within outlet 4 of collar 2, thus one or more of media tube 12 and helical frame 20, which frame extends from media tube 12 into deformable container 8 of media container 2. First passageway 18 is arranged within media tube 12. Nodule 28 is arranged at, extends from, or protrudes from, distal end 24 of helical frame 20, where proximal end 22 of helical frame 20 extends from media tube 12.

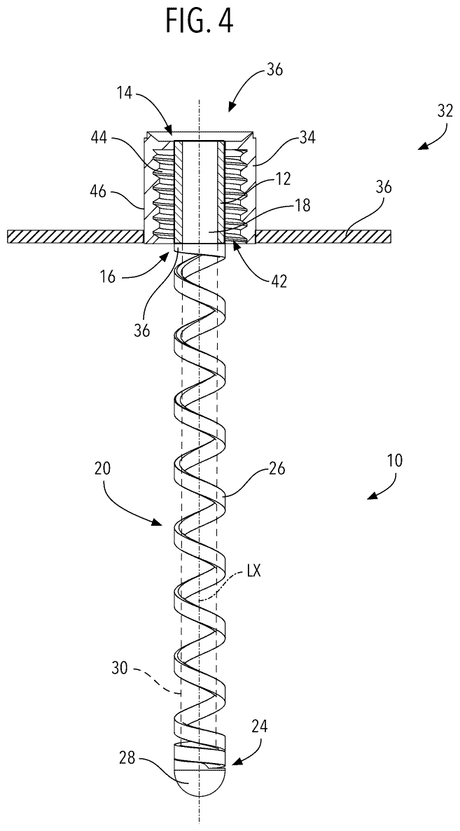

Media container 2 may further comprise an extension, e.g., extension 7 (See FIG. 5B) having a through-bore therein and in fluid communication with outlet 4, which extension extends distally from collar 6 in a direction opposite deformable container 8.

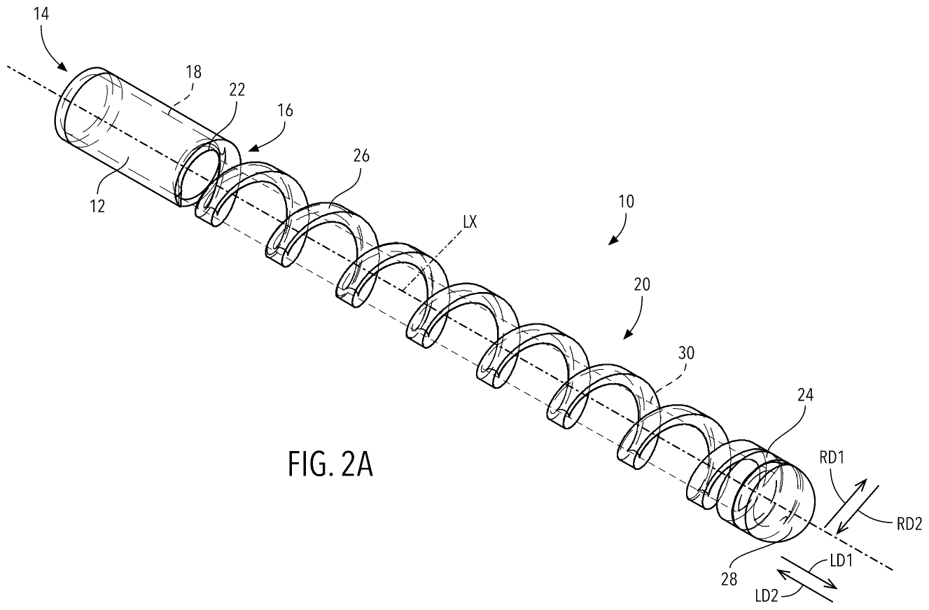

In some embodiments and in reference to FIG. 2A, conduit device 10 generally includes media tube 12 and helical frame 20. The media tube has first end 14 and second end 16. The first and second ends define respective openings to first passageway 18. The helical frame has proximal end 22 and distal end 24. The proximal and distal ends are terminations, or ends, of plurality of arcuate frame-members 26, which frame-members are interconnected to form a helix configuration that forms wall-less passageway 30, bounded by the respective inner surfaces of each arcuate frame member of the plurality. Nodule 28 protrudes, or extends, from distal end 24. Wall-less passageway 30 is an extension of first passageway 18, substantially forming a media passageway, a pathway which media is directed from around helical frame 20, within wall-less passageway 30 to proximal end 22 and into first passageway 18, to travel out of first end 14 of media tube 12. In a preferred configuration, both media tube 12 and helical frame 20 have a substantially identical outer diameter. Similarly, both first passageway 18 and wall-less passageway 30 have a substantially identical diameter. It can be said that the media tube is a passageway formed by a wall that transitions into a wall-less passageway.

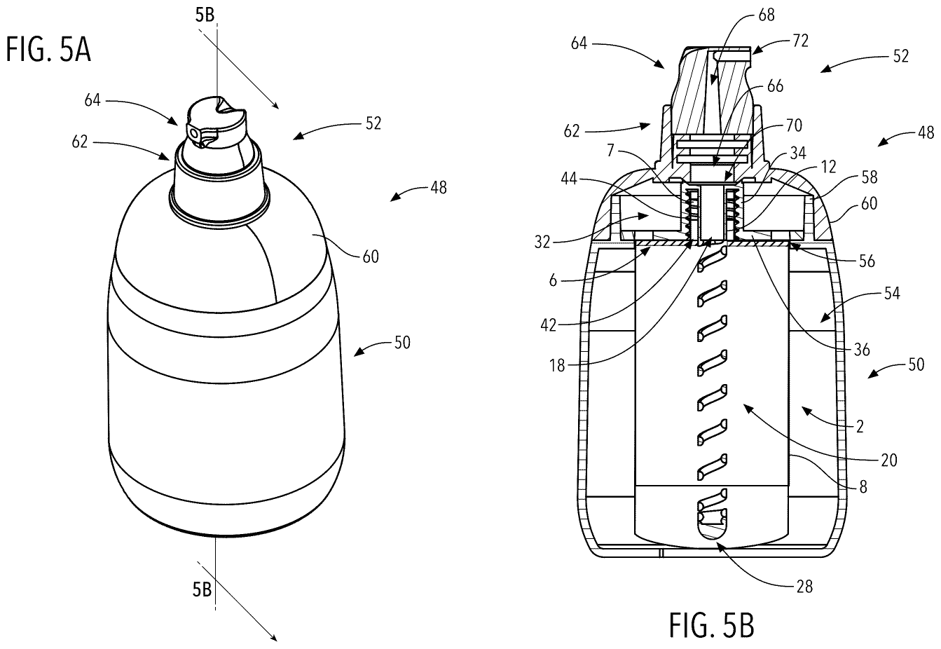

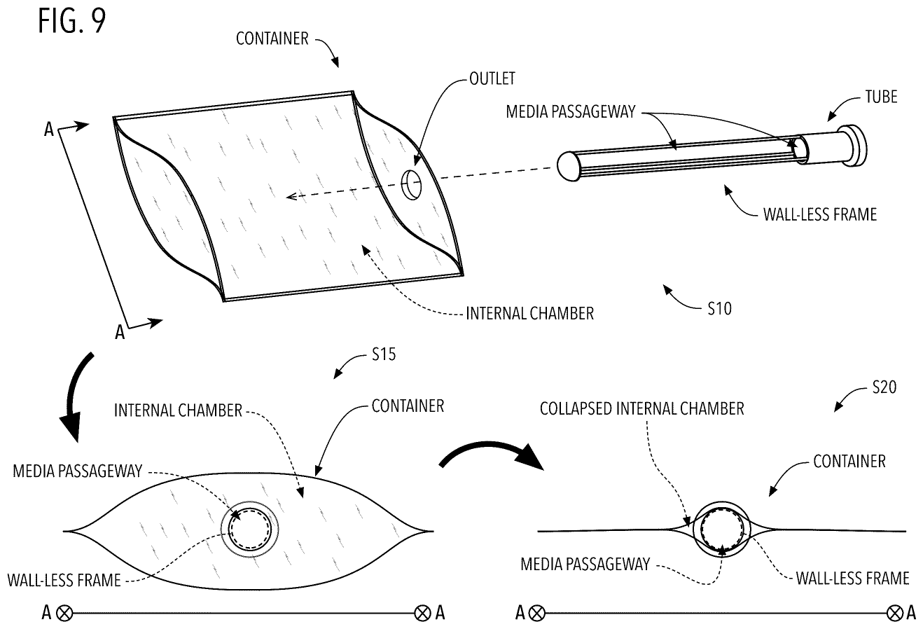

FIG. 2B generally illustrates a preferred embodiment of conduit device 10. As shown, FIG. 2B illustrates proximal ring 29, a flange, that extends radially from media tube 12 at first end 14 of media tube 12. As shown, proximal ring 29 has a greater diameter than media tube 12. Additionally, FIG. 2B illustrates another possible configuration of nodule 28, which resembles a partial hook. As shown in FIGS. 6A through 6X, nodule 28 may taken any one of a plurality of different configurations. Proximal ring 29 may be described as a “stopper,” where its diameter is selectable based on an actuator dispenser that is attached to conduit device 10, such that proximal ring 29 prevents conduit device 10 from be displaced into the actuator dispenser when suction forces are applied to a container or package that conduit device 10 is within. Additionally, proximal ring 29 may be used to prevent the same movement within an intermediate connector that fluidly connects an actuator dispenser and conduit device 10 (See FIGS. 10A and 10B).

In reference to FIGS. 1 through 2B, in application, the outer diameter would be a maximum diameter that allows one or more of media tube 12 or helical frame 20 to be inserted within a spout, or outlet, of a deformable media container, e.g., outlet 4 of media container 2. Illustrative examples may be toothpaste containers, squeezable food containers, lotion containers, or other any of deformable media container which is primarily designed to be compressed to direct and force media within to move and exit through a respective opening, discussed supra and generally illustrated as media container 2.

As media is dispensed from media container 2, either via an actuator, discussed infra, or via compression or force applied to deformable container 8 of media container 2, deformable container 8 collapses in one or more of a radial direction towards helical frame 8 or in a substantially longitudinal direction, e.g., LD2, towards media tube 12. Helical frame 20 prevents deformable container 8 from collapsing its respective “walls” onto itself and instead, will rest on the outer surface of one or more of helical frame 20 or nodule 28, thus, wall-less passageway 30 remains within helical frame 28, providing a media pathway, with minimal resistance, so media to be moves towards media tube 12 and through first passageway 18. Additionally, the design of helical frame 20 may also be substantially spring-like, or coil-like, such that as compression or forces are applied onto deformable container 8, distal end 24 and/or nodule 28 may translate in a direction towards proximal end 22 of helical frame 30, e.g., substantially in longitudinal direction LD2.

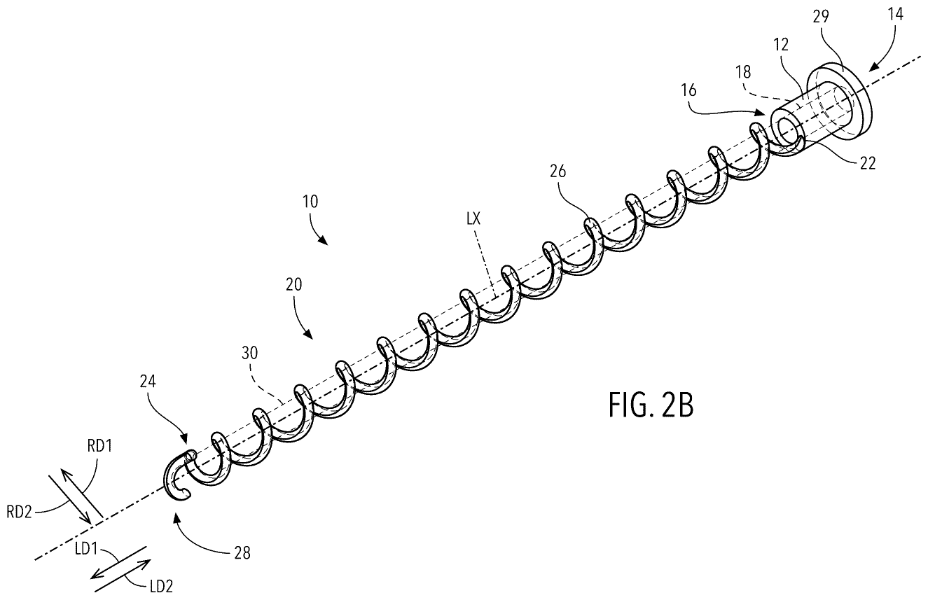

FIGS. 3A and 3B generally illustrate an exemplary embodiment of the present invention. As shown, conduit device 10 may further include connector 32. In one possible configuration, media tube 12 may be integrated into connector 32. Connector 32 may have first end 38 and second end 40, where body 34 is arranged proximate first end 38 and flange 36 extends from body 34 proximate second end. Body 34 could be described as an outer tube, relative to media tube 12. Body 34 and flange 36 have second passageway 42 arranged therein. Second passageway 42 is preferably a partial through-bore, and in some embodiments, may have threading 44 arranged on its inner surface. As shown, body 34 has media tube 12 extending therefrom and at least partially therein from second passageway 42. As such, body 34 has first passageway 18 arranged therein and having an opening proximate first end 38 of connector 32.

In a possible embodiment, connector 32, i.e., one or more of body 34 or flange 36, has first passageway 18 arranged therein and proximate first end 38 and second passageway 42 arranged therein and proximate second end 40, where media tube 12 is arranged at least partially within second passageway 42 and affixed proximate first end 38, e.g., within and extending from body 34. As shown, the outer surface of media tube 12 and the inner surface of second passageway 42 are spaced apart. In further embodiments, threading may be arranged on outer surface 46 of the outer tube, e.g., body 34, proximate first end 38 and threading 44 may be further arranged on the inner surface of second passageway 42, at least proximate second end 40.

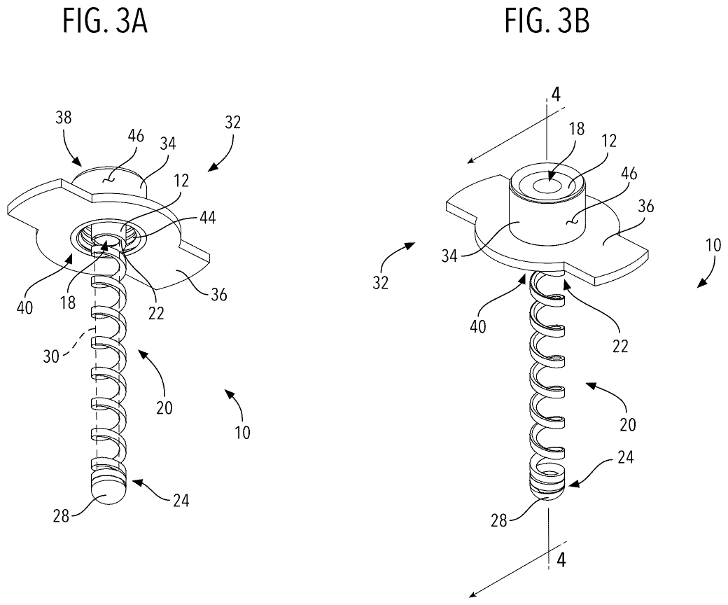

FIG. 4 is a semi-cross-section view taken approximately along line 4-4 in FIG. 3B, without a section view of helical frame 20, for clarity. As shown, first passageway 18 of media tube 12 and wall-less passageway 30 formed by plurality of arcuate members 26 substantially align to define a pathway for media to travel, a substantially open pathway, e.g., wall-less passageway 30, which partially directs media and a closed pathway, e.g., first passageway 18, which substantially directs media.

FIG. 4 also shows how first passageway 18 within media tube 12 is at least partially arranged within second passageway 42 within one or more of body 34 or flange 36, and first passageway 18 and second passageway 42 are spaced apart, providing a space therebetween where a spout of a media container could be inserted and removably engaged to second passageway 42, preferably by, but not limited to, threading 44.

The following description should be taken in view of all of the aforementioned figures and in further view of FIGS. 5A and 5B. FIG. 5A generally shows a perspective view of container assembly 48 and FIG. 5B is a cross-sectional view taken generally along line 5B-5B in FIG. 5A. Container assembly 48 may comprise outer container 50 and dispenser assembly 52. Outer container 50 may have internal cavity 54 arranged therein with opening 56 to the internal cavity. Annular ring 58 extends outer container 50 proximate opening 56. Dispenser assembly 52 may include collar 60, actuator housing 62 extending from collar 60, and actuator 64, translatably arranged within actuator housing 62. Actuator housing passageway 68 is arranged within actuator housing 62 and is in fluid communication with first passageway 18 of media tube 12, where body 34 of connector 32 is either fixedly connected actuator housing 62 or removably connected thereto. Dispenser passageway 68 is arranged within actuator 64 and is in fluid communication with actuator housing passageway 68. Actuator housing passageway 68 has inlet 70 and dispenser passageway 68 has outlet 72. Annular ring 58 may removably engage collar 60 via a plurality of removable connection components, such as, but not limited to, threading, snap-fit, quick-connections, etc.

As shown, extension 7 of media container 2 extends from collar 6, whereas extension may include threading to removable engage threading 44 of second passageway 42, thereby securing body 34 of connector 32 to media container 2, thus positioning at least a portion of one or more of media tube 12 and helical frame 20 within deformable container 8. In one possible embodiment and explained supra, actuator housing 62 is either fixedly secured or removably secured to body 34 of connector 32, thereby fluidly connecting passageways 18, 66, and 68, when media container 2 is removably connected to body 34 of connector 32, allowing collar 60 to engage outer container 50 to removably connect dispenser assembly 52 thereto.

Once assembled, a user may depress actuator 64, translating actuator 64 in a direction towards outer container 50 within actuator housing 62, which creates a negative pressure differential between the inside of deformable container 8 (which may have a media therein) and the outside atmosphere of deformable container 8. For example, in a non-limiting fashion, the aforementioned differential can be as great as approximately 14.7 pounds per square inch, thus if deformable container 8 is approximately three inches by four inches in size, the pressure differential created can generate as much as approximately 176 pounds of force on the respective external surface of deformable container 8, which forces media therein to travel into first passageway 18 within media tube 12, into inlet 70, through passageways 66 and 68, and out of outlet 72 of actuator 64. As media is continuously depleted from deformable container 8, helical frame 20 prevents the internal surfaces of media container 8 from completely collapsing and thus, provides a wall-less frame to sustain a media passageway from within media container 8 to first passageway 18 within media tube 12. As the pressure differential continues to collapse media container 8, e.g., possible in a direction towards media tube 12, helical frame 20, because of its coil-like, spring-like, etc., configuration, allows it to compress and/or collapse in a direction towards media tube 12 along with media container 8.

One having ordinary skill in the art should appreciate that the aforementioned dimensions and inherent ratios are representative and illustrative, thus such examples should not be considered restrictive on the appending claims.

Further, one having ordinary skill in the art will appreciate that dispenser assembly 52 is merely representative, and a plurality of different dispensers, actuators, etc., which utilize pressure differential to evacuate media and/or contents from one or more of a container or deformable container, may be employed in conjunction with the present invention, e.g., at least the wall-less frame and media tube, which may be configured as helical frame member 20.

FIGS. 6A through 6D illustrate various embodiments of a nodule of the present invention. As described above, helical frame 20 (or a wall-less frame) has nodule 28 arranged at distal end 24. FIG. 6A generally illustrates a dome-like, or hemispherical configuration of nodule 28. Nodule 28 extends from, or is arranged at, distal end 24 of helical frame 20, where nodule 28 is configured as hemisphere 74, thus having a rounded end extending from distal end 24. FIG. 6B generally illustrates a ball-like, or spherical configuration of nodule 28. Nodule 28 extends from, or is arranged at, distal end 24 of helical frame 20, where nodule 28 is configured as sphere 76, thus having a rounded outer surface. FIG. 6C generally illustrates a loop-like, hook-like, substantially donut like configuration of nodule 28. Nodule 28 extends from or is arranged at distal end 24 of helical frame, where nodule 28 is configured as loop 78, with end 80 curving and facing helical frame 20 and forming opening 82 therein and also forming space 80 substantially between distal end 24 and end 80. It should be noted that loop 78 could also comprise a donut-like configuration, where end 80 rejoins distal end 24 and thus eliminating space 84. Lastly, FIG. 6D illustrates a possible configuration of helical frame 20 where there is no nodule present at distal end 24 of helical frame 20. It should be noted that in a possible embodiment where no nodule is present, helical frame 20 is preferably constructed of a softer, pliable, squeezable material, such that distal end 24 will not puncture a container it is arranged within.

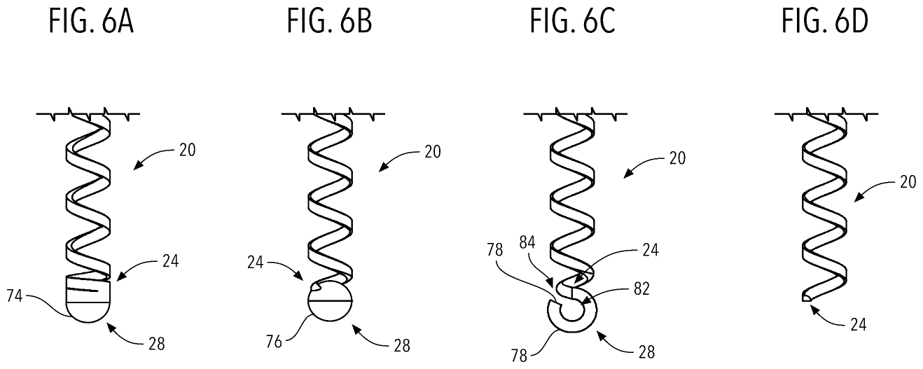

FIG. 7 illustrates another possible embodiment of the present invention, conduit device 100. Conduit device 100 has proximal end 102 and distal end 104, media tube 106 arranged proximate proximal end 102 and nodule 110 arranged proximate distal end 104 with wall-less frame 108 disposed substantially therebetween. Media tube 106 has passageway 114 arranged therein and with respective openings, one opening facing proximal end 102 and another opening facing distal end 104. Wall-less frame 108 comprises at least one of frame member 112, e.g., wall-less frame 108 may have three of frame member 112 extending from and connected to both media tube 106 and nodule 110. Wall-less frame 108, via at least one frame member 112, forms and substantially bounds passageway 116 therein. Media tube 106 also includes proximal ring 107, which is substantially identical to the proximal ring described on the conduit device shown in FIG. 2B.

One, or many, of frame member 112 could take multiple forms, such as the longitudinal pole-like configuration, or a wire-like configuration, generally shown in FIG. 7. Frame 112 could be a single member and could take the configuration of helical frame 20 of conduit device 10, as generally illustrated in FIG. 2. Thus, it can be said that helical frame 20 of conduit device 10 is one possible configuration of a wall-less frame. It should be noted that the configuration of a wall-less frame is restricted to configurations which provide substantial space, or substantial voids, into passageway 116. If one or more of the material or configuration of a selected frame has a greater amount of structure compared to the space or void, e.g., approximately 50% or more, such material and/or configuration is not a wall-less frame. This is an important ratio of structure to space because the greater the structure, the greater the resistance the structure will impart on media being introduced into passageway 116, thereby limiting the effectiveness of media evacuation from a particular container. This is of even greater importance if a selected media has a higher viscosity.

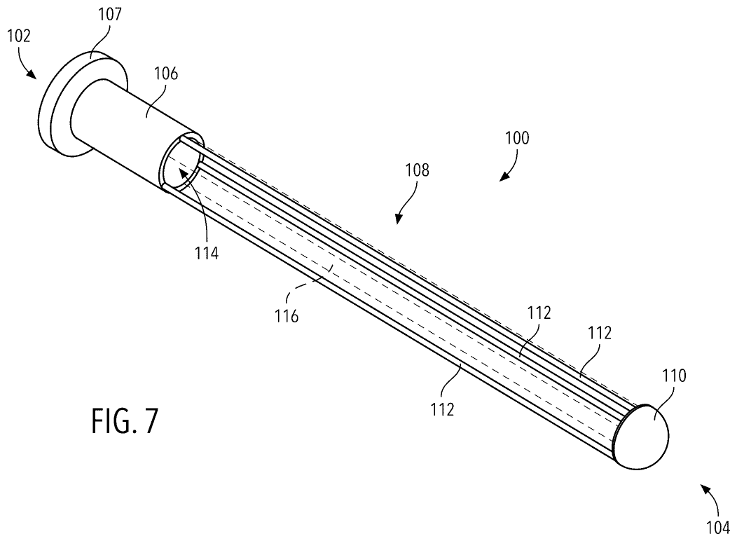

In reference to FIGS. 8A through 8C, media tube 12 (or media tube 106 as shown in FIG. 7), could be designed in an elongated configuration having a plurality of one or more of slots or apertures within the elongated portion thereof. As shown in FIGS. 8A through 8C, extension 120 of media tube 12, could be described generally as perforated tube, having a plurality of apertures and/or slots arranged therein, e.g., apertures 130-134. In one possible configuration, extension 120 is a section of media 12 arranged between media tube 12 and helical frame 20 (or wall-less frame 108 as shown in FIG. 7 and described supra). Extension 120 may comprise first end 122, which generally is the integration or connection of second end 16 of media tube 12, second end 124, and perforated passageway 126 disposed between ends 122 and 124. Preferably, apertures 130-134 are arranged substantially between ends 122 and 124, circumferentially and equally spaced. As shown, apertures 130-134 are generally elongated and ovular-slot-like, however, such depiction is exemplary in that various different quantities and shapes of the apertures are contemplated within the scope of the appending claims.

It should be noted that extension 120 may be considered a wall-less frame, depending on the size and quantity of the apertures, however, it should be noted that extension 120 preferably comprises more material circumscribing its inner passageway when compared to wall-less frame 108 in FIG. 7 or helical frame 20, thus it can be appreciated that the resistance of media moving through perforated passageway 126 is greater than the resistance of media moving through wall-less passageway 30. It can also be said that the combination of extension 120 and one or more of wall-less frame 108 or helical frame 20 forms a combination-type wall-less frame, i.e., a wall-less frame having different degrees of resistance on media passing therethrough.

In some embodiments, connector 32, specifically body 34, may further include connection extension 138 extending from first end 38 of body 34. Connection extension 138 may be configured with a pair of annular channels, e.g., annular channels 140 and 142. Annular channels 140 and 142 are configured to interact with connection elements 144 and 146 which may be arranged within actuator housing 62. Connection elements 144 and 146, also annular channels 140 and 142, may take a variety of forms which allow connection extension 138 to be sealably connected to actuator housing 62, thus fluidly connecting first passageway 18, housing passageway 66 and dispenser passageway 68. Not limiting examples may include, O-ring frictional fit configurations, snap-fit configurations, quick-connection configurations, threading, etc., and such possible connection options may encompass any known designs that facilitate and maintain the fluid connection of the aforementioned passageways. Further, it should be noted that connection extension 138 could be fixedly secured to and/or within actuator housing 62.

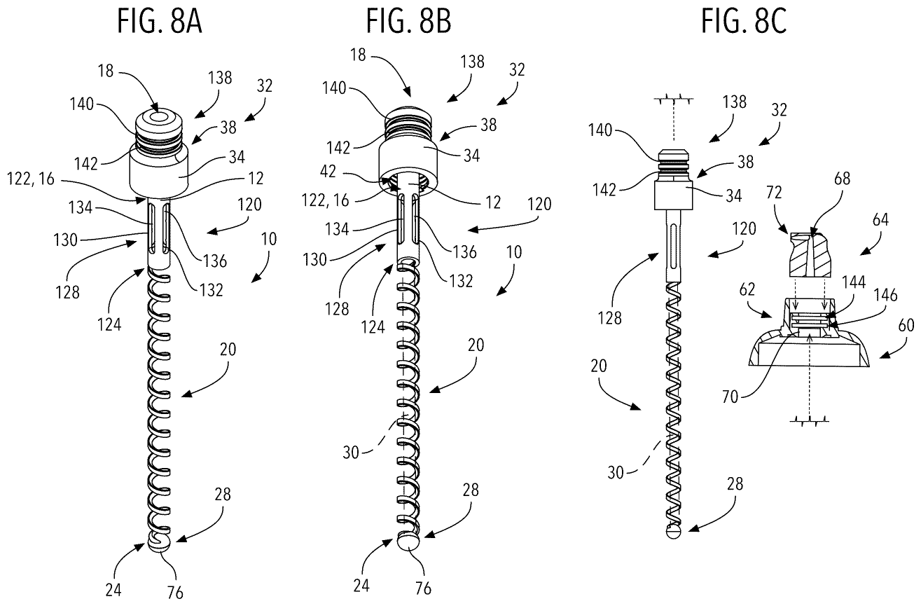

The following description pertains to a method of the present invention and the references numerals should be taken in view of the aforementioned description and FIG. 9. It should be noted that the reference numerals are exemplary and should not be considered restrictive on the appending claims.

In particular reference to FIG. 9, generally, the present invention may include a method for improving evacuation of media within a deformable container (2, 8), the container having an internal chamber in fluid communication with an outlet (4), the method comprising: First step S10, inserting a wall-less frame (20, 108) within the outlet (4) to be seated within the internal chamber, the frame (20, 108) being connected to a tube (12, 106) and the tube (12, 106) being arranged to be at least partially seated within the outlet (4); Second step S15, forming, via the frame (20, 108), a media passageway to the outlet (30, 116); and, Third step S20, maintaining, via the frame (20, 108), the media passageway (30, 116) to the tube (12, 106) when, or if, the internal chamber (8) of the deformable container (2, 8) collapses as media is evacuated therefrom. The method may also include the step of connecting an actuator (64) to the tube (See FIGS. 5B and 8C), thereby allowing the actuator (64) to create a vacuum within the internal chamber upon actuation, which actuation collapses the internal chamber as media is evacuated therefrom. It should be noted that the tube (12, 106) may also include a proximal ring (29, 107) radially extending therefrom which is thereby design to prevent one or more of: the tube (12, 106) from being displaced entirely within the outlet (4); or, the tube (12, 106) from being displaced into at least one of an actuator dispenser and a intermediate connector and no longer being at least partially seated within the outlet (4).

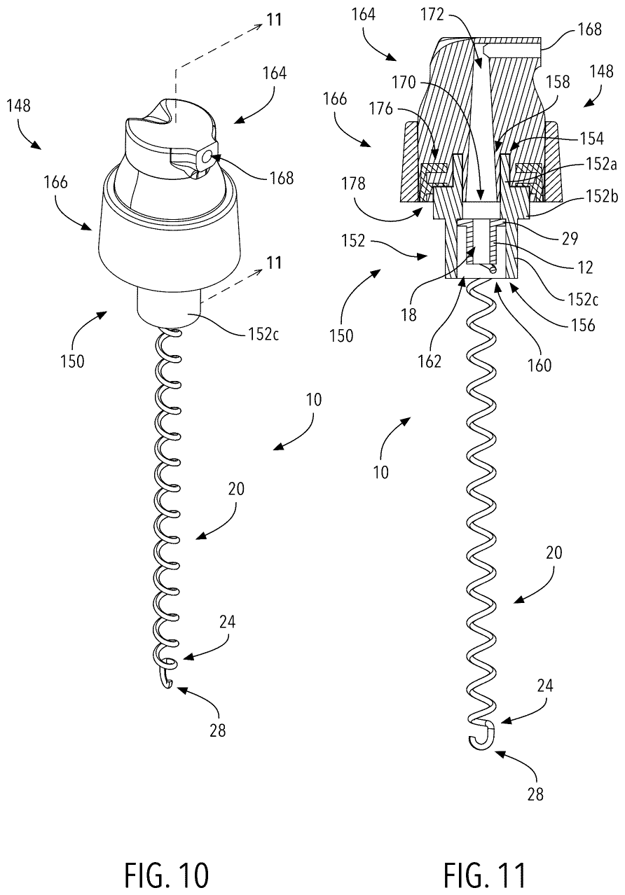

The following description should be taken in view of the aforementioned figures and with specific reference to FIGS. 10 and 11, which figures generally illustrate a dispenser in fluid connection with one or the one or more aforementioned conduit devices via an intermediate connection member. In an illustrative configuration, intermediate connector 150 removably connects conduit device 10 and dispenser 148, in a frictional manner, thereby fluidly connecting first passageway 18 of media tube 12 of conduit device 10 with passageway 172 within dispenser 148. It should be noted that dispenser 148 is a known-in-the-art pump head that is traditionally used within another number of typical consumer goods, such as lotions, cosmetics, and the like, as detailed supra, and its described components are merely illustrative to give intermediate connector 150 practical context. Thus, one having skill in the art would appreciate and understand that variations of dispenser 148 are contemplated within the scope of the present disclosure and such variations imply that intermediate connector 150 may be modified to accommodate a proper fluid connection with dispenser 148. As such, dispenser 148 includes actuator head 164 that is designed to translate within collar 166. Dispenser 148 also includes pump mechanism 176 which may comprise any number of known mechanisms. For example, pump mechanism 176 may include one or more of stem, piston, spring, ball (e.g., interior components inside the housing) and may function by pressing down on actuator 164, moving the piston to compress a spring and causing upward air pressure to draw a ball upwardly, along with media within an attached container or package, into media tube 12, passageway 162 and then passageway 172. As the user releases actuator 164, the spring returns the piston and actuator into its up position, and the ball is returned to its resting position, sealing passageway 162 and preventing the media from flowing back down into the container or package.

In one possible design, intermediate connector 150 comprises body 152 which includes one or more variable-diameter sections, e.g., proximal section 152a, medial section 152b, and distal section 152c. In representative fashion and as shown in FIG. 11, medial section 152b has the greatest diameter, proximal section 152a has the smallest diameter, and distal section 152c has a diameter than is smaller than the diameter of medial section 152b but is larger than the diameter of proximal section 152c. This relationship is of course variable with respect to the diameters of the connection components of dispenser 148, e.g., an outer diameter of internal stem 174 and/or an internal diameter of opening 178. Body 152 has proximal end 154 and distal end 156 which have proximal opening 158 and distal opening 160 respectively disposed therein. Openings 158 and 160 are the openings of passageway 162 which is disposed therebetween and within body 152. As shown, passageway 162 has multiple diameters, facilitating a Venturi effect of media that passes therethrough. A distal diameter of passageway 162, e.g., a distal portion of passageway 162 disposed within distal section 152c, is greater than a proximal diameter of passageway 162, e.g., a proximal portion of passageway 162 disposed within one or more of medial section 152b or proximal section 152a, preferably both. The transition from the distal portion to the proximal portion of passageway 162 forms an edge, creating a stop that prevents media tube 12 from being inserted into the proximal portion of passageway 162 via proximal ring 29, as media tube 12 has an outer diameter that is preferably less than or equal to the diameter of the proximal section of passageway 162. This configuration, creates an annular space between an outer surface of media tube 12 and an internal surface of the distal section of passageway 162, thereby allowing a spout or throat of a container or package to be frictionally inserted within distal section 152c of body 152 and the spout or throat of the container of package to accept conduit device 10 therethrough-fluidly connecting the container or package to intermediate connector 150.

Preferably, intermediate connector 150 is made of a semi-flexible or pliable material, such as silicon or other materials sharing these characteristics. This allows for a frictional and fluid-tight connection between components inserted within passageway 162 at openings 158 and 160. As such, the diameter of the distal portion of passageway 162 will be slightly less than the diameter of the component inserted therein, e.g., the throat or spout of a container and proximal ring 29, and the diameter of the proximal portion of passageway 162 will be slightly less than the diameter of the component inserted therein, e.g., stem 174 of dispenser 148. Thus, in other possible configurations, passageway 162 could have a constant diameter between openings 158 and 160, so long as the constant diameter of passageway 162 is at least slightly less than the diameter of proximal ring 29, such that proximal ring 29 is frictionally secured within passageway 162 that suctional force will not draw proximal ring 29 within passageway 162 towards proximal opening 158 beyond its preselected position within passageway 162.

It will be appreciated that various aspects of the invention and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

2 Media container
4 Outlet
6 Collar
7 Extension
8 Deformable container
10 Conduit device
12 Media tube
14 First end
16 Second end
18 First passageway
20 Helical frame
22 Proximal end
24 Distal end
26 Plurality of arcuate frame-members
28 Nodule
29 Proximal ring
30 Wall-less passageway
32 Connector
34 Body
36 Flange
38 First end
40 Second end
42 Second passageway
44 Threading
46 Outer surface
48 Container assembly
50 Outer container
52 Dispenser assembly
54 Internal cavity
56 Opening
58 Annular ring
60 Collar
62 Actuator housing
64 Actuator
66 Actuator housing passageway
68 Dispenser passageway
70 Inlet
72 Outlet
74 Hemisphere
76 Sphere
78 Loop
80 End
82 Opening
84 Space
100 Conduit device
102 Proximal end
104 Distal end
106 Media tube
107 Proximal ring
108 Wall-less frame
110 Nodule
112 Frame member
114 Passageway
116 Passageway
120 Extension
122 First end
124 Second end
126 Perforated passageway
128 Plurality of apertures
130 Aperture
132 Aperture
134 Aperture
136 Aperture
138 Connection extension
140 Proximal annular channel
142 Distal annular channel
144 Connection element
146 Connection element
148 Dispenser
150 Intermediate connector
152 Body
152a Proximal section
152b Medial section
152c Distal section
154 Proximal end
156 Distal end
158 Proximal opening
160 Distal opening
162 Passageway
164 Actuator head
166 Collar
168 Outlet
170 Inlet
172 Passageway
174 Stem
176 Mechanism
178 Opening
LX Longitudinal axis
LD1 Longitudinal direction
LD2 Longitudinal direction
RD1 Radial direction
RD2 Radial direction
S10 Step 1
S15 Step 2
S20 Step 3

What is claimed is:

1. A conduit device, comprising:
a media tube having a first end and a second end defining a first passageway therein, the first end having a flange extending radially therefrom; and,
a substantially helical frame extending from said second end of said media tube, said helical frame having a nodule affixed to a distal end thereof, wherein one or more of said media tube or said helical frame is adapted to be at least partially arranged within a deformable media container, thereby creating a media passageway within said helical frame when said deformable media container collapses around said helical frame.

2. The conduit device recited in claim 1 further comprising:
an outer tube having a first end and a second end, said outer tube having the first passageway arranged therein and proximate said first end and a second passageway arranged therein and proximate said second end, wherein said media tube is arranged at least partially within said second passageway and affixed proximate said first end.

3. The conduit device recited in claim 2, wherein an outer surface of said media tube and an inner surface of said second passageway are spaced apart.

4. The conduit device recited in claim 3, wherein threading is arranged on an outer surface of said outer tube proximate said first end and threading is further arranged on said inner surface of said second passageway proximate said second end.

5. The conduit device recited in claim 4, wherein said threading of said inner surface of said second passageway is adapted to be threadably secured to a threaded portion of said deformable media container.

6. The conduit device recited in claim 4, wherein said threading of said outer surface of said outer tube is adapted to be threadably secured to a dispenser assembly.

7. The conduit device recited in claim 1, wherein said nodule may be configured as one or more of: substantially spherical, substantially hemispherical, substantially cylindrical, substantially annular, or a partial loop.

8. The conduit device recited in claim 1, wherein said media tube further comprises an extension portion arranged between said second end of said media tube and said helical frame, said extension portion having a plurality of apertures arranged therein.

9. A conduit device, comprising:
a media tube having a first end and a second end defining a first passageway therein, the first end having a flange extending radially therefrom; and,
a wall-less frame extending from said second end of said media tube, said wall-less frame having at least one frame member extending distally from said second end of said media tube, wherein one or more of said media tube or said wall-less frame is adapted to be at least partially arranged within a deformable media container, thereby creating a media passageway within said wall-less frame when said deformable media container collapses around said wall-less frame.

10. The conduit device recited in claim 9, wherein said at least one frame member comprises a helical frame.

11. The conduit device recited in claim 10 further comprising a nodule affixed to a distal end of said wall-less frame.

12. The conduit device recited in claim 11, wherein said nodule may be configured as one or more of: substantially spherical, substantially hemispherical, substantially cylindrical, substantially annular, or a partial loop.

13. The conduit device recited in claim 10 further comprising:
a dispenser assembly having a dispenser passageway arranged therein;
wherein, said dispenser assembly is connected to said media tube, thereby fluidly connecting said passageways and forming an evacuation passageway for media within said deformable media container to travel from said deformable media container and out of said dispenser assembly.

14. The conduit device recited in claim 10, wherein said media tube further comprises an extension portion arranged between said second end of said media tube and said wall-less, said extension portion having a plurality of apertures arranged therein.

15. A conduit device, comprising:
a media tube having a first end and a second end defining a first passageway therein;
a wall-less frame extending from said second end of said media tube, said wall-less frame having at least one frame member extending distally from said second end of said media tube; and, one or more of:
a flange extending radially from the first end of the media tube; or,
an extension portion arranged between said second end of said media tube and said wall-less, said extension portion having a plurality of apertures arranged therein,
wherein one or more of said media tube or said wall-less frame is adapted to be at least partially arranged within a deformable media container, thereby creating a media passageway within said wall-less frame when said deformable media container collapses around said wall-less frame.

16. The conduit device recited in claim 15, wherein said at least one frame member comprises a helical frame.

17. The conduit device recited in claim 15 further comprising a nodule affixed to a distal end of said wall-less frame.

18. The conduit device recited in claim 15 further comprising:
an intermediate connector with a first end and a second end defining a body therebetween, the connector having a second passageway with a first opening disposed within the first end and a second opening disposed within the second end, the first opening arranged to accept and frictionally secure the media tube therein, thereby fluidly connecting the first and second passageways, the second opening being arranged to accept and frictionally secure a conduit of a dispensing actuator therein.
